(19) United States
(12) Patent Application Publication
(10) Pub. No.: US 2025/0220701 A1
(43) Pub. Date: Jul. 3, 2025

(54) METHOD AND DEVICE FOR UPLINK TRANSMISSION, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/841,957

(22) PCT Filed: Feb. 28, 2022
(86) PCT No.: PCT/CN2022/078459

§ 371 Date: Aug. 27, 2024

(51) Int. Cl. H04W 74/00; H04W 72/0446; H04W 84/06

(52) U.S. Cl. CPC H04W 74/004; H04W 72/0446; H04W 84/06

(57) ABSTRACT

A method, apparatus and computer readable medium for improving reliability and effectiveness of the uplink transmission in the satellite communication system. The reliability and effectiveness are improved by: receiving a system message that includes a plurality of candidate numerical values and is transmitted by a base station; determining a first numerical value from the plurality of candidate numerical values; and transmitting a first preamble sequence to the base station, where the first preamble sequence is configured to indicate the first numerical value.

### CROSS-REFERENCE TO RELATED APPLICATIONS

The present application is a U.S. National Stage of International Application No. PCT/CN2022/078459, filed on Feb. 28, 2022, the contents of all of which are incorporated herein by reference in their entirety for all purposes.

### BACKGROUND OF THE INVENTION

In the research of wireless communication technology, satellite communication is considered indispensable to its future development. The satellite communication refers to communication established by ground-based communication devices with a satellite as a relay. A satellite communication system consists of a satellite segment and a ground segment.

### SUMMARY OF THE INVENTION

The present disclosure relates to the field of communication, in particular to a method and device for uplink transmission, and a storage medium. In order to overcome the problem in the related art, a method and device for uplink transmission, as well as a storage medium, are provided according to embodiments of the present disclosure, which can be applied to a satellite communication system. This ensures that the base station and terminal have a consistent understanding of the numerical values for the uplink transmission, thereby improving the reliability and effectiveness of uplink transmission.

According to a first aspect of an embodiment of the present disclosure, a method for transmitting information is provided. The method is performed by a terminal and includes:
receiving a system message that includes a plurality of candidate numerical values and is transmitted by a base station;
determining a first numerical value from the plurality of candidate numerical values; and
transmitting a first preamble sequence to the base station, where the first preamble sequence is configured to indicate the first numerical value.

According to a second aspect of the examples of the present disclosure, a method for receiving information is provided. The method is performed by a base station and includes:
transmitting a system message including a plurality of candidate numerical values to a terminal;
receiving a first preamble sequence transmitted by the terminal, where the first preamble sequence is configured to indicate a first numerical value determined by the terminal from the plurality of candidate numerical values; and
determining the first numerical value used by the terminal based on the first preamble sequence.

According to a third aspect of the examples of the present disclosure, a non-transitory computer-readable storage medium is provided. The storage medium stores a computer program, where the computer program when executed by one or more processors cause the one or more processors to collectively execute the method for transmitting information according to the first aspect.

According to a fourth aspect of the examples of the present disclosure, a non-transitory computer-readable storage medium is provided. The storage medium stores a computer program, where the computer program when executed by one or more processors cause the one or more processors to collectively execute the method for receiving information according to the second aspect.

According to a fifth aspect of the examples of the present disclosure, a communication device is provided. The communication device includes:
one or more processors; and
a memory that stores instructions executable by the one or more processors, where the one or more processors are configured to execute the instructions and the instructions cause the communication device to: receive a system message that comprises a plurality of candidate numerical values and is transmitted by a base station; determine a first numerical value from the plurality of candidate numerical values; and transmit a first preamble sequence to the base station, where the first preamble sequence is configured to indicate the first numerical value.

According to a sixth aspect of the examples of the present disclosure, a communication device is provided. The communication device includes:
one or more processors; and
a memory that stores instructions executable by the one or more processors, where the one or more processors are configured to execute the instructions and the instructions cause the communication device to perform the method for receiving information according to the second aspect.

It should be understood that the above general description and the following detailed description are merely illustrative and explanatory, which cannot limit the present disclosure.

### BRIEF DESCRIPTION OF DRAWINGS

The drawings herein are incorporated in the description as a constituent part of the description, which illustrate examples of the present disclosure and serve to explain principles of the present disclosure along with the description.

FIG. 1A is a schematic diagram of a scenario of uplink and downlink alignment at a base station side according to an example.

FIG. 1B is a schematic diagram of a scenario of uplink and downlink misalignment at a base station side according to an example.

FIG. 2 is a schematic flowchart of a method for uplink transmission according to an example.

FIG. 3 is a schematic flowchart of a method for uplink transmission according to another example.

FIG. 4 is a schematic flowchart of a method for uplink transmission according to another example.

FIG. 5 is a schematic flowchart of a method for uplink transmission according to another example.

FIG. 6 is a schematic flowchart of a method for uplink transmission according to another example.

FIG. 7 is a schematic flowchart of a method for uplink transmission according to another example.

FIG. 8 is a schematic flowchart of a method for uplink transmission according to another example.

FIG. 9 is a schematic flowchart of a method for uplink transmission according to another example.

FIG. 10 is a schematic flowchart of a method for uplink transmission according to another example.

FIG. 11 is a schematic flowchart of a method for uplink transmission according to another example.

FIG. 12 is a schematic flowchart of a method for uplink transmission according to another example.

FIG. 13 is a schematic flowchart of a method for uplink transmission according to another example.

FIG. 14 is a schematic flowchart of a method for uplink transmission according to another example.

FIG. 15 is a schematic flowchart of a method for uplink transmission according to another example.

FIG. 16 is a schematic flowchart of a method for uplink transmission according to another example.

FIG. 17 is a block diagram of a device for uplink transmission according to an example.

FIG. 18 is a block diagram of a device for uplink transmission according to another example.

FIG. 19 is a schematic structural diagram of a communication device according to an example of the present disclosure.

FIG. 20 is a schematic structural diagram of a communication device according to another example of the present disclosure.

### DETAILED DESCRIPTION OF THE INVENTION

Description will be made in detail to examples here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the examples of the present disclosure. Rather, they are merely instances of devices and methods consistent with some aspects of the appended examples of the present disclosure.

The terms used in the examples of the present disclosure is for the purpose of describing particular embodiments merely and are not intended to limit the examples of the present disclosure. As used in the examples of the present disclosure, singular forms “a,” “an” and “the/said” are intended to include plural forms as well, unless otherwise indicated in the context clearly. It should be understood that the term “and/or” as used here refers to and encompasses any or all possible combinations of at least one of associated listed items.

It should be understood that although the terms of “first,” “second,” “third” and the like may be used in the examples of the present disclosure to describe various information, such information should not be limited to these terms. These terms are merely used to distinguish the same type of information from each other. For example, first information may also be referred to as second information, and similarly, second information may also be referred to as first information, without departing from the scope of the examples of the present disclosure. The word “if” as used here may be construed to mean “at the time of,” or “when,” or “in response to determining,” depending on the context.

The satellite communication features a wide communication range, which allows communication between any two points within the range covered by radio waves emitted by the satellite; and insusceptibility to terrestrial disasters (i.e., high reliability). As a supplement to a current terrestrial cellular communication system, the satellite communication supports extended coverage and communication in areas that are beyond coverage of the current cellular communication system or are high in coverage cost, such as oceans, deserts and remote mountainous areas. Satellite communication can be used for emergency communication even if the cellular communication infrastructure is out of service due to extreme disasters such as earthquakes. In addition, the satellite communication can provide industry applications, for example, delay-sensitive services with long-distance transmission, to shorten delays of service transmission by using the satellite communication.

It is foreseeable that, in future wireless communication systems, satellite communication systems and terrestrial cellular communication systems will gradually achieve deep integration, truly realizing the vision of a fully connected world.

In satellite communication systems, a segment-based transmission mechanism is supported for uplink transmission, and the value of the segment can be notified to the terminal by the base station. If the message sent by the base station to the terminal includes a plurality of numerical values, i.e., a plurality of segment values, the terminal needs to select one of the values for the corresponding transmission. However, the base station and terminal cannot maintain a consistent understanding of the numerical value chosen by the terminal. On the other hand, if the message from the base station to the terminal includes only one segment value, it results in a significant signaling overhead for the base station and also leads to excessive power consumption by the terminal.

Before introducing an uplink transmission solution provided by the present disclosure, methods for timing adjustment in a satellite communication scenario are introduced first.

In the first method, considering the long signal transmission distance between the transmitting end and the receiving end in a satellite communication scenario, which results in longer data transmission time, the relevant standardization discussions have determined the introduction of a parameter Koffset to compensate for the transmission delay in a case where there is an uplink-downlink relationship.

The parameter Koffset may be applied to a variety of operations, including but not limited to transmission of a physical uplink share channel (PUSCH) for scheduling of downlink control information (DCI), and feedback information of hybrid automatic repeat request (HARQ).

In a second method, timing advance (TA) may be used, and a terminal transmits a data packet in advance.

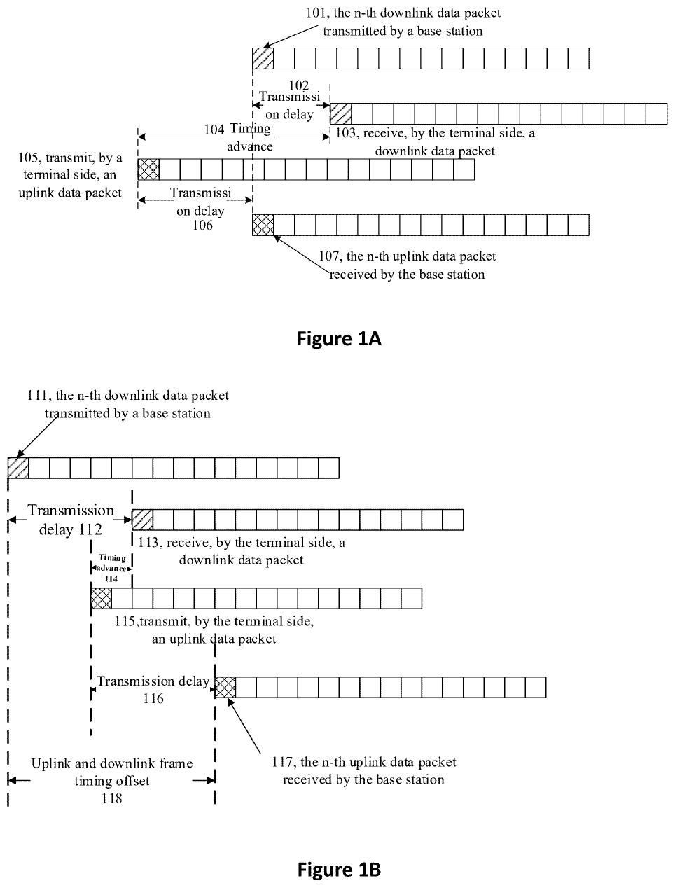

Referring to FIG. 1A, the n-th downlink data packet 101 sent by a base station reaches a terminal side after a certain transmission delay 102. The n-th uplink data packet 105 sent by the terminal has a specified TA 104 value relative to the received n-th downlink data packet 103, allowing the time point at which the n-th uplink data packet 107 arrives at the base station side to meet a predetermined requirement of the error range relative to the time point at which the base station sent the n-th downlink data packet. This achieves uplink and downlink timing alignment at the base station side.

Alternatively, as shown in FIG. 1B, uplink and downlink timings at the base station side may be misaligned. In this case, there is a specified frame timing offset 118 between the n-th downlink data packet 111 transmitted by the base station side and the n-th uplink data packet 117 received by the base station side.

Timing adjustment can be implemented by any one of the methods described above.

In the satellite communication system, the TA may change significantly as a result of rapid movement of a satellite, causing the terminal side to make timely timing adjustment based on the changed TA during uplink transmission accordingly, which results in high energy consumption at the terminal side.

On the other hand, for uplink transmission, If the message sent by the base station to the terminal includes a plurality of segment values, the base station and terminal cannot maintain a consistent understanding of the numerical value chosen by the terminal. If the message from the base station to the terminal includes only one segment value, the base station has to send a plurality of messages to inform the terminal of a plurality of segment values, resulting in a significant signaling overhead for the base station and excessive power consumption of the terminal.

In order to solve the technical problems and improve reliability and effectiveness of the uplink transmission in the satellite communication system, a method for uplink transmission is provided according to the present disclosure. Next, the method for uplink transmission provided by the present disclosure will be provided from a terminal side.

A method for uplink transmission is provided according to an embodiment of the present disclosure. With reference to FIG. 2, FIG. 2 is a flowchart of a method for uplink transmission according to an example. The method may be performed by a terminal. The method may include steps 201 to 203 as follows.

In step 201, a system message that includes a plurality of candidate numerical values and is transmitted by a base station is received.

In an embodiment of the present disclosure, since the terminal has not yet accessed the base station, the plurality of candidate numerical values configured by the base station may be determined through the system message transmitted by the base station. The numerical value here refers to a segment value.

In one embodiment, a segment may be a parameter corresponding to data transmission. For example, in a case where the segment is 10 milliseconds, the terminal may divide the data to be transmitted into segments of 10 milliseconds each and then send these segments to the base station. Alternatively, when the terminal repeats data transmission, it may repeat the specified data every 10 milliseconds.

In step 202, a first numerical value is determined from the plurality of candidate numerical values.

In step 203, a first preamble sequence is transmitted to the base station.

In the example of the present disclosure, the first preamble sequence may be further configured to indicate the first numerical value in addition to enabling random access of the terminal. In other words, the terminal implicitly informs, through the first preamble sequence, the base station of the first numerical value determined by the terminal from the plurality of candidate numerical values. This ensures that the base station and terminal have a consistent understanding of the numerical value, i.e., the value of the segment.

In this embodiment, it effectively ensures that the base station and the terminal in a satellite communication system have a consistent understanding of the numerical value for uplink transmission, thereby improving the reliability and effectiveness of uplink transmission.

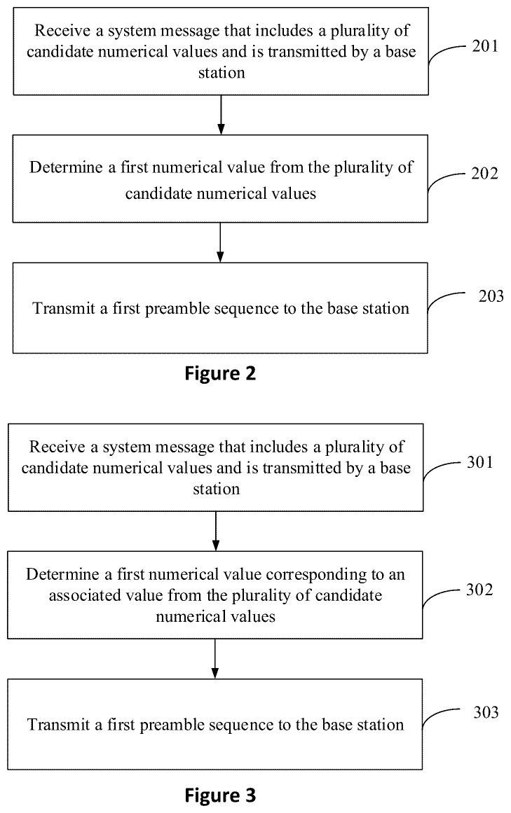

In some optional examples, with reference to FIG. 3, FIG. 3 is a flowchart of a method for uplink transmission according to an example. The method may be performed by a terminal. The method may include steps 301 to 303 as follows.

In step 301, a system message that includes a plurality of candidate numerical values and is transmitted by a base station is received.

In the example of the present disclosure, since the terminal has not yet accessed the base station, the plurality of candidate numerical values configured by the base station may be determined through the system message transmitted by the base station.

The system message received by the terminal may include first indication information in addition to the plurality of candidate numerical values. The first indication information is configured to indicate an associated value of the first numerical value.

In one embodiment, the associated value includes but is not limited to at least one of an angle value of a link between the terminal and a satellite relative to a horizontal plane or a timing advance (TA) value corresponding to the terminal.

According to the first indication information, the terminal may determine the first numerical value based on the angle value and/or the TA value.

In step 302, a first numerical value corresponding to an associated value is determined from the plurality of candidate numerical values.

In the example of the present disclosure, in a case where the associated value indicated by the first indication information is the angle value, the terminal may determine the angle value of the link between the terminal and the satellite relative to the horizontal plane. Further, based on a correspondence relationship between a plurality of different angle values and a plurality of numerical values, the terminal may determine a numerical value corresponding to an angle value currently determined by the terminal from the plurality of candidate numerical values as the first numerical value.

Alternatively, in a case where the associated value indicated by the first indication information is the TA value, the terminal may determine a numerical value corresponding to a current TA value from the plurality of candidate numerical values based on a correspondence relationship between a plurality of different TA values and a plurality of numerical values as the first numerical value.

Alternatively, in a case where the associated values indicated by the first indication information are the angle value and TA value, after determining its angle value and TA value by the above method, the terminal may determine a numerical value that corresponds to the current angle value and the current TA value of the terminal from the plurality of candidate numerical values based on a correspondence relationship among a plurality of different angle values, a plurality of TA values and a plurality of numerical values as the first numerical value.

The correspondence relationship may be predefined by a protocol, or determined by the base station and then transmitted to the terminal, which is not limited by the present disclosure.

In step 303, a first preamble sequence is transmitted to the base station.

In the example of the present disclosure, the first preamble sequence may be further configured to indicate the first numerical value in addition to enabling random access of the terminal. In other words, the terminal implicitly informs, through the first preamble sequence, the base station of the first numerical value determined by the terminal. This ensures that the base station and terminal have a consistent understanding of the first numerical value.

In the example described above, the terminal may determine, based on the system message, the plurality of candidate numerical values configured by the base station. The terminal may further determine the first numerical value based on the associated value indicated by the first indication information in the system message, to indicate the first numerical value through the first preamble sequence later. This ensures that the base station and terminal in the satellite communication system have a consistent understanding of the numerical value of uplink transmission, enabling the implementation to be simple and with high usability.

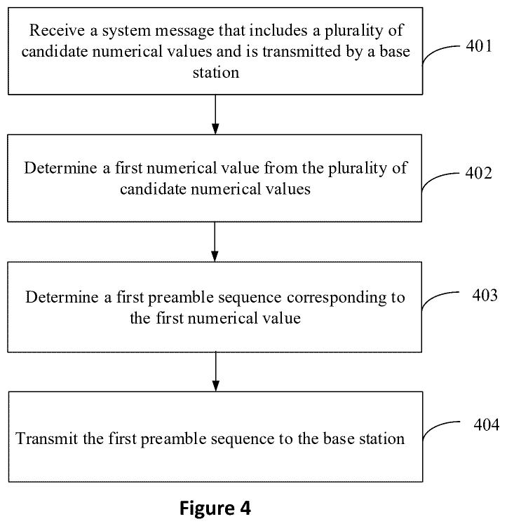

In some optional examples, with reference to FIG. 4, FIG. 4 is a flowchart of a method for uplink transmission according to an example. The method may be applied to a terminal. The method may include steps 401 to 404 as follows.

In step 401, a system message that includes a plurality of candidate numerical values and is transmitted by a base station is received.

In the example of the present disclosure, since the terminal has not yet accessed the base station, the plurality of candidate numerical values configured by the base station may be determined through the system message transmitted by the base station.

In step 402, a first numerical value is determined from the plurality of candidate numerical values.

In the example of the present disclosure, the terminal may determine the first numerical value using the method in the embodiments described above, which will not be repeated here.

In step 403, a first preamble sequence corresponding to the first numerical value is determined.

In the example of the present disclosure, a correspondence relationship between a plurality of different numerical values and a plurality of preamble sequences may be predefined by the protocol. Alternatively, a correspondence relationship between a plurality of different numerical values and a plurality of preamble sequences may be determined by the base station and then transmitted to the terminal.

For example, the correspondence relationship between the plurality of different numerical values and the plurality of preamble sequences may be shown in Table 1.

TABLE 1

| Preamble sequence | Segment value |
|---|---|
| Preamble 1 to Preamble N | Segment value 1 |
| Preamble N + 1 to Preamble M | Segment value 2 |
| . . . | . . . |
| Preamble x to Preamble y | Segment value S |

In the example of the present disclosure, the terminal may determine the first numerical value based on the angle value and/or the TA value. Assuming that the first numerical value is the Segment value 1, the terminal may select one preamble sequence from Preamble 1 to Preamble N as the first preamble sequence based on Table 1.

In step 404, a first preamble sequence is transmitted to the base station.

In the example of the present disclosure, the terminal transmits the first preamble sequence to the base station for random access, to access the base station. In addition, the terminal may further perform corresponding transmission based on the first numerical value.

After receiving the first preamble sequence, the base station side may not only complete random access to the terminal based on the first preamble sequence but also determine the first numerical value used by the terminal based on the correspondence relationship in Table 1. This ensures that both the base station and terminal have a consistent understanding of the first numerical value. Later, when the terminal performs transmission based on the first numerical value, the base station may further receive data based on the first numerical value.

In this embodiment, it effectively ensures that the base station and the terminal in the satellite communication system have a consistent understanding of the numerical value for uplink transmission, thereby improving the reliability and effectiveness of the uplink transmission.

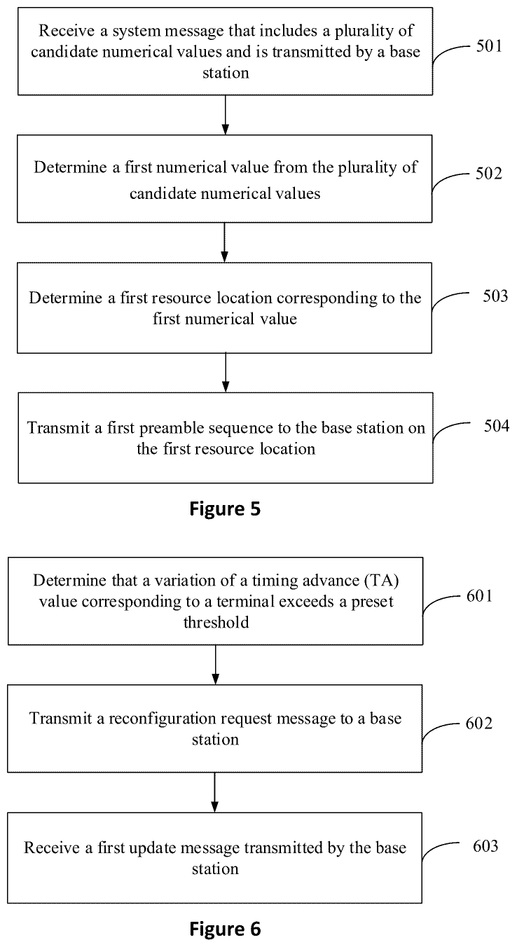

In some optional examples, with reference to FIG. 5, FIG. 5 is a flowchart of a method for uplink transmission according to an example. The method may be applied to a terminal. The method may include steps 501 to 504 as follows.

In step 501, a system message that includes a plurality of candidate numerical values and is transmitted by a base station is received.

In the example of the present disclosure, since the terminal has not yet accessed the base station, the plurality of candidate numerical values configured by the base station may be determined through the system message transmitted by the base station.

In step 502, a first numerical value is determined from the plurality of candidate numerical values.

In the example of the present disclosure, the terminal may determine the first numerical value using the method in the embodiments described above, which will not be repeated here.

In step 503, a first resource location corresponding to the first numerical value is determined.

In the example of the present disclosure, the first resource location may be a resource location occupied by a first preamble sequence.

In one possible embodiment, a correspondence relationship between a plurality of different preamble sequences and a plurality of different resource locations may be predefined by the protocol. Alternatively, a correspondence relationship between a plurality of different preamble sequences and a plurality of different resource locations may be determined by the base station and then transmitted to the terminal.

For example, the correspondence relationship between the plurality of different preamble sequences and the plurality of resource locations may be shown in Table 2.

TABLE 2

| Resource location occupied by | |
|---|---|
| a first preamble sequence | Segment value |
| Resource location 1 | Segment value 1 |
| Resource location 2 | Segment value 2 |
| . . . | . . . |
| Resource location s | Segment value S |

In the example of the present disclosure, the terminal may determine the first numerical value based on the angle value and/or the TA value. Assuming that the first numerical value is the Segment value 2, the terminal may determine that the first resource location corresponding to the first numerical value is the resource location 2 based on Table 2.

In step 504, a first preamble sequence is transmitted to the base station on the first resource location.

In the example of the present disclosure, the terminal transmits the first preamble sequence to the base station on the first resource location, to initiate random access and access the base station. In addition, the terminal may further perform corresponding transmission based on the first numerical value. The first preamble sequence transmitted on the first resource location may be any preamble sequence, which is not limited by the present disclosure.

After receiving the first preamble sequence, the base station side may not only complete random access to the terminal based on the first preamble sequence but also determine the first numerical value corresponding to the first resource location occupied by the first preamble sequence based on the correspondence relation in Table 2. This ensures that both the base station and terminal have a consistent understanding of the first numerical value. Later, when the terminal performs transmission based on the first numerical value, the base station may further receive data based on the first numerical value.

In this embodiment, it effectively ensures that the base station and the terminal in the satellite communication system have a consistent understanding of the numerical value for uplink transmission, thereby improving the reliability and effectiveness of the uplink transmission.

In some optional examples, with reference to FIG. 6, FIG. 6 is a flowchart of a method for uplink transmission according to an example. The method may be applied to a terminal. The method may include steps 601 to 603 as follows.

In step 601, it is determined that a variation of a TA value corresponding to the terminal exceeds a preset threshold.

In the example of the present disclosure, after the terminal enters a connected state, the terminal may determine whether the variation of a corresponding TA value exceeds the preset threshold.

In Step 602, a reconfiguration request message is transmitted to the base station.

In the example of the present disclosure, in a case where the variation of the TA exceeds the preset threshold, the terminal may actively transmit the reconfiguration request message to the base station. The reconfiguration request message is configured to request the base station to reconfigure a numerical value for the terminal.

In step 603, a first update message transmitted by the base station is received.

In the example of the present disclosure, the first update message may be a radio resource control (RRC) message. The first update message includes a new numerical value that is reconfigured by the base station for the terminal. The terminal may perform corresponding transmission later based on the new numerical value.

In the example, after the terminal enters the connected state, the terminal may actively trigger reconfiguration the segment value. In this way, in the satellite communication system, numerical value update can be supported, and flexibility of numerical value configuration can be improved. In addition, it effectively ensures that the base station and the terminal have a consistent understanding of the numerical value for uplink transmission, thereby improving the reliability and effectiveness of the uplink transmission.

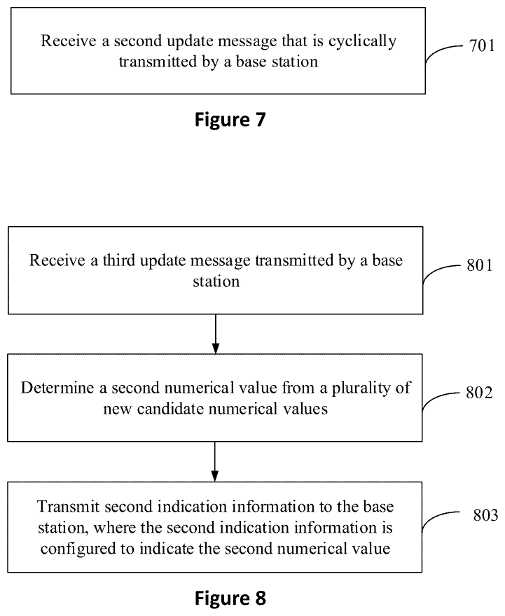

In some optional examples, with reference to FIG. 7, FIG. 7 is a flowchart of a method for uplink transmission according to an example. The method may be applied to a terminal. The method may include as follows.

In step 701, a second update message cyclically transmitted by a base station is received.

In the example of the present disclosure, the base station may cyclically transmit the second update message. The second update message includes a new numerical value reconfigured by the base station for the terminal. The terminal may subsequently perform corresponding transmission based on the new numerical value.

In the example, after the terminal enters the connected state, the base station may cyclically reconfigure the segment value. In this way, in the satellite communication system, numerical value update can be supported, and the flexibility of numerical value configuration can be improved. In addition, it effectively ensures that the base station and the terminal have a consistent understanding of the numerical value for uplink transmission, thereby improving the reliability and effectiveness of the uplink transmission.

In some optional examples, with reference to FIG. 8, FIG. 8 is a flowchart of a method for uplink transmission according to an example. The method may be applied to a terminal. The method may include steps 801 to 803 as follows.

In step 801, a third update message transmitted by a base station is received.

In the example of the present disclosure, the third update message includes a plurality of new candidate numerical values reconfigured by the base station for the terminal.

In step 802, a second numerical value is determined from the plurality of new candidate numerical values.

In the example of the present disclosure, the terminal may determine the second numerical value from the plurality of new candidate numerical values. The method for determining the second numerical value is similar to the method for determining the first numerical value described above, which will not be repeated here.

In step 803, second indication information is transmitted to the base station, where the second indication information is configured to indicate the second numerical value.

In one implementation, the second indication information may explicitly indicate the second numerical value.

For example, the second numerical value is the Segment2, and the second indication information may include 3 bits. Bit values of these 3 bits directly indicate the second numerical value, i.e., the second indication information may be 010.

In another implementation, the second indication information may implicitly indicate the second numerical value.

The second indication information includes specified information, and the terminal may determine one piece of specified information corresponding to the second numerical value according to a correspondence relationship between a plurality of different numerical values and a plurality of pieces of different specified information. The specified information is transmitted to the base station, to enable the base station to determine the second numerical value. The type of the specified information is not limited in the present disclosure.

The description above is merely illustrative, and any method for implicitly indicating the second numerical value through one piece of indication information should fall within the protection scope of the present disclosure.

In the example, after the terminal enters the connected state, the base station reconfigures the plurality of candidate numerical values. In this way, in the satellite communication system, numerical value update can be supported, and flexibility of numerical value configuration can be improved. In addition, it effectively ensures that the base station and the terminal have a consistent understanding of the numerical value for uplink transmission, thereby improving the reliability and effectiveness of the uplink transmission.

Next, a method for uplink transmission according to the present disclosure will be provided from a base station side.

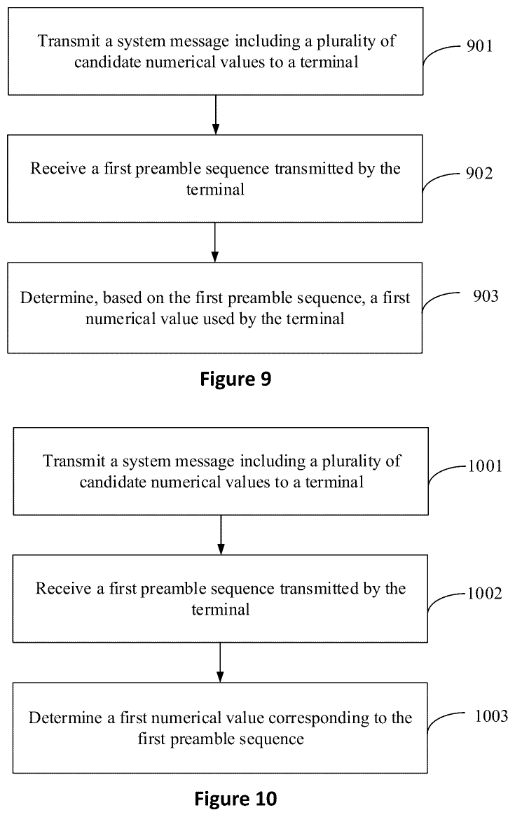

A method for uplink transmission is provided according to an embodiment of the present disclosure. With reference to FIG. 9, FIG. 9 is a flowchart of a method for uplink transmission according to an example. The method may be performed by a base station. The method may include steps 901 to 903 as follows.

In step 901, a system message including a plurality of candidate numerical values is transmitted to a terminal.

In the example of the present disclosure, since the terminal has not yet accessed the base station, the base station may transmit the plurality of candidate numerical values to the terminal through the system message.

In step 902, a first preamble sequence transmitted by the terminal is received.

In addition to initiating random access, the function of the first preamble sequence may be further configured to indicate the first numerical value determined by the terminal from the plurality of candidate numerical values.

In step 903, the first numerical value used by the terminal is determined based on the first preamble sequence.

In this embodiment, it effectively ensures that the base station and the terminal in the satellite communication system have a consistent understanding of the numerical value for uplink transmission, thereby improving the reliability and effectiveness of the uplink transmission.

In some optional examples, the system message may further include first indication information in addition to the plurality of candidate numerical values. The first indication information is configured to indicate an associated value of the first numerical value.

In one implementation, the associated value includes, but is not limited to, at least one of an angle value of a link between the terminal and a satellite relative to a horizontal plane or a TA value corresponding to the terminal.

According to the first indication information, the terminal side may determine the first numerical value based on the angle value and/or the TA value. Further, the terminal side may determine the first numerical value corresponding to the associated value from the plurality of candidate numerical values based on a correspondence relationship between a plurality of different associated values and a plurality of different numerical values. The correspondence relationship between the plurality of different associated values and the plurality of different numerical values may be defined by the protocol, or determined by the base station and then transmitted to the terminal.

In some optional examples, with reference to FIG. 10, FIG. 10 is a flowchart of a method for uplink transmission according to an example. The method may be performed by a base station. The method may include steps 1001 to 1003 as follows.

In step 1001, a system message including a plurality of candidate numerical values is transmitted to a terminal.

In the example of the present disclosure, since the terminal has not yet accessed the base station, the base station may transmit the plurality of candidate numerical values to the terminal through the system message.

In step 1002, a first preamble sequence transmitted by the terminal is received.

In addition to initiating random access, the function of the first preamble sequence may be further configured to indicate the first numerical value determined by the terminal from the plurality of candidate numerical values.

In step 1003, the first numerical value corresponding to the first preamble sequence is determined.

In the example of the present disclosure, the base station may determine the first numerical value corresponding to the first preamble sequence according to Table 2 described above. The correspondence relationship shown in Table 2 may be predefined by the protocol, or determined by the base station and then transmitted to the terminal, which is not limited by the present disclosure.

In the example described above, the base station may determine the first numerical value corresponding to the first preamble sequence received. In this way, it ensures that the base station and the terminal have a consistent understanding of the numerical value for uplink transmission, thereby enabling high usability.

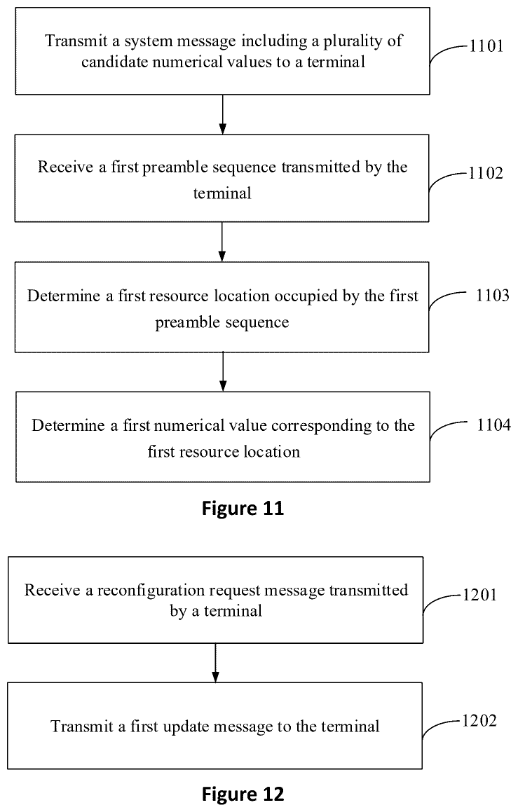

In some optional examples, with reference to FIG. 11, FIG. 11 is a flowchart of a method for uplink transmission according to an example. The method may be performed by a base station. The method may include steps 1101 to 1104 as follows.

In step 1101, a system message including a plurality of candidate numerical values is transmitted to a terminal.

In the example of the present disclosure, since the terminal has not yet accessed the base station, the base station may transmit the plurality of candidate numerical values to the terminal through the system message.

In step 1102, a first preamble sequence transmitted by the terminal is received.

In addition to initiating random access, the function of the first preamble sequence may be further configured to indicate the first numerical value determined by the terminal from the plurality of candidate numerical values.

In step 1103, a first resource location occupied by the first preamble sequence is determined.

In step 1104, the first numerical value corresponding to the first resource location is determined.

In the example of the present disclosure, the base station may determine the first numerical value corresponding to the first resource location according to Table 2 described above. The correspondence relationship shown in Table 2 may be predefined by the protocol, or determined by the base station and then transmitted to the terminal, which is not limited by the present disclosure.

In the example described above, the base station may determine the first numerical value corresponding to the first resource location occupied by the received first preamble sequence. In this way, it ensures that the base station and the terminal have a consistent understanding of the numerical value for uplink transmission, thereby enabling high usability.

In some optional examples, with reference to FIG. 12, FIG. 12 is a flowchart of a method for uplink transmission according to an example. The method may be performed by a base station. The method may include steps 1201 to 1202 as follows.

In step 1201, a reconfiguration request message transmitted by a terminal is received.

In the example of the present disclosure, the reconfiguration request message is configured to request the base station to reconfigure a numerical value for the terminal. After the terminal enters a connected state, the base station may receive the reconfiguration request message transmitted by the terminal.

In step 1202, a first update message is transmitted to the terminal.

In the example of the present disclosure, the first update message includes a new numerical value reconfigured by the base station for the terminal.

In this embodiment, in the satellite communication system, numerical value update can be supported, and flexibility of numerical value configuration can be improved. In addition, it effectively ensures that the base station and the terminal have a consistent understanding of the numerical value for uplink transmission, thereby improving the reliability and effectiveness of the uplink transmission.

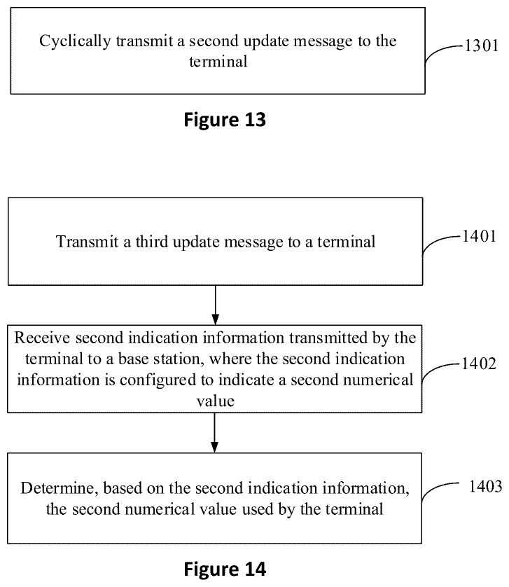

In some optional examples, with reference to FIG. 13, FIG. 13 is a flowchart of a method for uplink transmission according to an example. The method may be performed by a base station. The method may include as follows.

In step 1301, a second update message is cyclically transmitted to a terminal.

The second update message includes a new numerical value reconfigured by the base station for the terminal.

In this embodiment, in the satellite communication system, numerical value update can be supported, and flexibility of numerical value configuration can be improved. In addition, it effectively ensures that the base station and the terminal have a consistent understanding of the numerical value for uplink transmission, thereby improving the reliability and effectiveness of the uplink transmission.

In some optional examples, with reference to FIG. 14, FIG. 14 is a flowchart of a method for uplink transmission according to an example. The method may be performed by a base station. The method may include steps 1401 to 1403 as follows.

In step 1401, a third update message is transmitted to a terminal.

In the example of the present disclosure, the third update message includes a plurality of new candidate numerical values reconfigured by the base station for the terminal.

In step 1402, the second indication information transmitted by the terminal to a base station is received, where the second indication information is configured to indicate a second numerical value.

The second numerical value is determined by the terminal from the plurality of new candidate numerical values.

In one implementation, the base station receives the second indication information that is carried by the terminal during segment-based transmission.

In step 1403, the second numerical value used by the terminal is determined based on the second indication information.

In one implementation, the second indication information explicitly indicates the second numerical value.

In another implementation, the second indication information implicitly indicates the second numerical value.

For example, the second indication information includes specified information, and the base station may determine a numerical value corresponding to the specified information that is included in the second indication information according to a correspondence relationship between a plurality of different numerical values and a plurality of pieces of different specified information as the second numerical value. The type of the specified information is not limited in the present disclosure.

In this embodiment, after the terminal enters the connected state, the base station reconfigures the plurality of candidate numerical values. In this way, in the satellite communication system, numerical value update can be supported, and the flexibility of numerical value configuration can be improved. In addition, it effectively ensures that the base station and the terminal have a consistent understanding of the numerical value for uplink transmission, thereby improving the reliability and effectiveness of the uplink transmission.

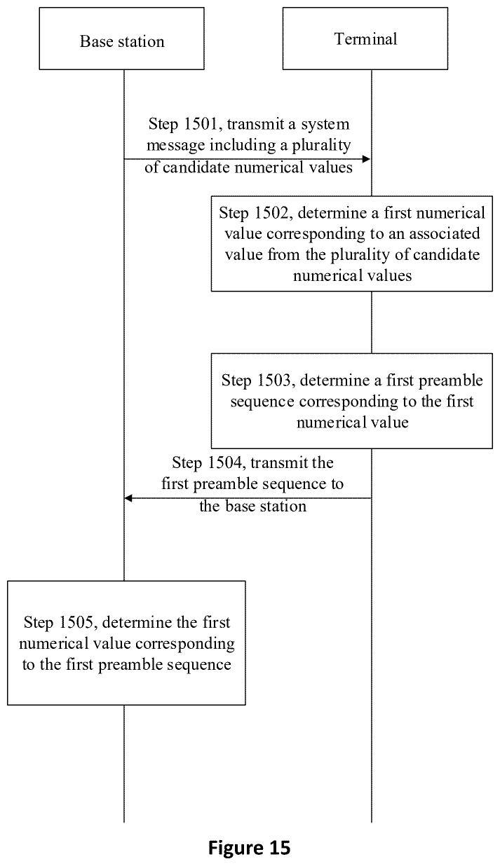

In some optional examples, with reference to FIG. 15, FIG. 15 is a flowchart of a method for uplink transmission according to an example. The method may include steps 1501 to 1505 as follows.

In step 1501, a system message including a plurality of candidate numerical values is transmitted by a base station.

In the example of the present disclosure, the base station may broadcast the system message.

The system message may further include first indication information. The first indication information is configured to indicate an associated value of a first numerical value. The associated value includes at least one of an angle value of a link between the terminal and a satellite relative to a horizontal plane or a TA value corresponding to the terminal.

In step 1502, a first numerical value corresponding to an associated value is determined by the terminal from the plurality of candidate numerical values.

In step 1503, a first preamble sequence corresponding to the first numerical value is determined by terminal.

In step 1504, the first preamble sequence is transmitted by the terminal to the base station.

In step 1505, the first numerical value corresponding to the first preamble sequence is determined by the base station.

In this embodiment, in the satellite communication system, it effectively ensures that the base station and the terminal have a consistent understanding of the numerical value for uplink transmission, thereby improving the reliability and effectiveness of the uplink transmission.

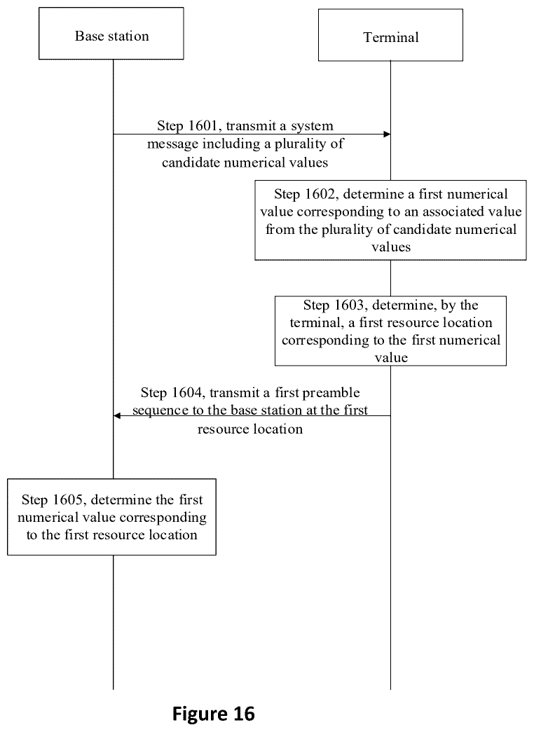

In some optional examples, with reference to FIG. 16, FIG. 16 is a flowchart of a method for uplink transmission according to an example. The method may include steps 1601 to 1605 as follows.

In step 1601, a system message including a plurality of candidate numerical values is transmitted by a base station.

In the example of the present disclosure, the base station may broadcast the system message.

The system message may further include first indication information. The first indication information is configured to indicate an associated value of a first numerical value. The associated value includes at least one of an angle value of a link between the terminal and a satellite relative to a horizontal plane or a TA value corresponding to the terminal.

In step 1602, a first numerical value corresponding to an associated value is determined by the terminal from the plurality of candidate numerical values.

In step 1603, a first resource location corresponding to the first numerical value is determined by the terminal.

In the example of the present disclosure, the first resource location is a resource location occupied by the first preamble sequence.

In step 1604, the first preamble sequence is transmitted to the base station by the terminal on the first resource location.

In step 1605, the first numerical value corresponding to the first resource location is determined by the base station.

In this embodiment, in the satellite communication system, it effectively ensures that the base station and the terminal have a consistent understanding of the numerical value for uplink transmission, thereby improving the reliability and effectiveness of the uplink transmission.

In some optional examples, the base station may update the segment value specifically as follows.

In a first case, the base station updates one numerical value.

Mode 1: the base station updates one numerical value based on triggering by the terminal.

The specific implementation is similar to the implementations of embodiments corresponding to FIG. 6 and FIG. 12, which will not be repeated here.

Mode 2: the base station cyclically updates one numerical value.

The specific implementation is similar to the implementations of embodiments corresponding to FIG. 7 and FIG. 13, which will not be repeated here.

In a second case, the base station updates a plurality of numerical values.

The base station may transmit a third update message that includes a plurality of new candidate numerical values. The terminal may determine a second numerical value from the plurality of new candidate numerical values, and then transmit second indication information to the base station, to inform the base station of the second numerical value.

The specific implementation is similar to the implementations of embodiments corresponding to FIG. 8 and FIG. 14, which will not be repeated here.

In this embodiment, after the terminal enters the connected state, the base station reconfigures the plurality of candidate numerical values. In this way, in the satellite communication system, numerical value update can be supported, and flexibility of numerical value configuration can be improved. In addition, it effectively ensures that the base station and the terminal have a consistent understanding of the numerical value for uplink transmission, thereby improving the reliability and effectiveness of the uplink transmission.

Corresponding to the method embodiments for implementing application functions described above, embodiments of devices for implementing application functions are provided in the present disclosure.

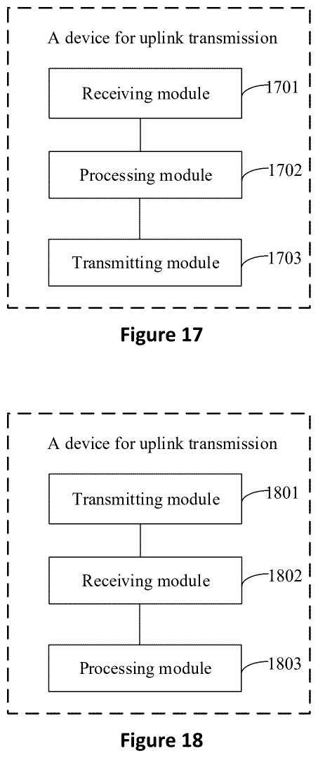

With reference to FIG. 17, FIG. 17 is a block diagram of a device for uplink transmission according to an example. The device includes as follows.

A receiving module 1701, configured to receive a system message that includes a plurality of candidate numerical values and is transmitted by a base station.

A processing module 1702, configured to determine a first numerical value from the plurality of candidate numerical values.

A transmitting module 1703, configured to transmit a first preamble sequence to the base station, where the first preamble sequence is configured to indicate the first numerical value.

In some optional examples, the system message includes first indication information, where the first indication information is configured to indicate an associated value of the first numerical value.

In some optional examples, the associated value includes at least one of an angle value of a link between the terminal and a satellite relative to a horizontal plane or a TA value corresponding to the terminal.

In some optional examples, the processing module is further configured to:
determine the first numerical value corresponding to the associated value from the plurality of candidate numerical values.

In some optional examples, the first numerical value has a correspondence relationship with the first preamble sequence.

In some optional examples, the processing module is further configured to:
determine a first resource location corresponding to the first numerical value, where the first resource location is a resource location occupied by the first preamble sequence.

The transmitting module is further configured to transmit the first preamble sequence to the base station on the first resource location.

In some optional examples, the processing module is further configured to:
determine that a variation of a TA value corresponding to the terminal exceeds a preset threshold.

The transmitting module is further configured to transmit a reconfiguration request message to the base station, where the reconfiguration request message is configured to request the base station to reconfigure a numerical value for the terminal.

The receiving module is further configured to:
receive a first update message transmitted by the base station, where the first update message includes a new numerical value reconfigured by the base station for the terminal.

In some optional examples, the receiving module is further configured to:
receive a second update message that is cyclically transmitted by the base station, where the second update message includes a new numerical value reconfigured by the base station for the terminal.

In some optional examples, the receiving module is further configured to:
receive a third update message transmitted by the base station, where the third update message includes a plurality of new candidate numerical values reconfigured by the base station for the terminal.

The processing module is further configured to:
determine a second numerical value from the plurality of new candidate numerical values.

The transmitting module is further configured to:
transmit second indication information to the base station, where the second indication information is configured to indicate the second numerical value.

With reference to FIG. 18, FIG. 18 is a block diagram of a device for uplink transmission according to an example. The device includes as follows.

A transmitting module 1801, is configured to transmit a system message including a plurality of candidate numerical values to a terminal.

A receiving module 1802, is configured to receive a first preamble sequence transmitted by the terminal, where the first preamble sequence is configured to indicate a first numerical value determined by the terminal from the plurality of candidate numerical values.

A processing module 1803, is configured to determine the first numerical value used by the terminal based on the first preamble sequence.

In some optional examples, the system message includes first indication information, where the first indication information is configured to indicate an associated value of the first numerical value.

In some optional examples, the associated value includes at least one of an angle value of a link between the terminal and a satellite relative to a horizontal plane or a TA value corresponding to the terminal.

In some optional examples, the processing module is further configured to:
determine the first numerical value corresponding to the first preamble sequence.

In some optional examples, the processing module is further configured to:
determine a first resource location occupied by the first preamble sequence; and
determine the first numerical value corresponding to the first resource location.

In some optional examples, the receiving module is further configured to:
receive a reconfiguration request message transmitted by the terminal, where the reconfiguration request message is configured to request the base station to reconfigure a numerical value for the terminal.

The transmitting module is further configured to:
transmit a first update message to the terminal, where the first update message includes a new numerical value reconfigured by the base station for the terminal.

In some optional examples, the transmitting module is further configured to:
transmit a second update message to the terminal cyclically, where the second update message includes a new numerical value reconfigured by the base station for the terminal.

In some optional examples, the transmitting module is further configured to:
transmit a third update message to the terminal, where the third update message includes a plurality of new candidate numerical values reconfigured by the base station for the terminal.

The receiving module is further configured to:
receive second indication information transmitted by the terminal to the base station, where the second indication information is configured to indicate a second numerical value, and the second numerical value is determined by the terminal from the plurality of new candidate numerical values.

The processing module is further configured to:
determine the second numerical value used by the terminal based on the second indication information.

For the device embodiments, since the embodiments basically corresponds to the method embodiments, reference can be made to description of the method embodiments for relevant contents. The device embodiments described above is merely illustrative, the units described as separated components may be physically separated or not, and the components displayed as the units may be physical units or not, i.e., the components may be located in one place or distributed over a plurality of network units. Some or all of the modules can be selected according to actual needs to achieve the objectives of the solutions of the present disclosure. The description above can be understood and implemented by those skilled in the art without creative efforts.

Accordingly, a computer-readable storage medium is further provided according to the present disclosure. The storage medium stores a computer program, where the computer program is configured to execute any method for uplink transmission performed at a terminal side as above.

Accordingly, a computer-readable storage medium is further provided according to the present disclosure. The storage medium stores a computer program, where the computer program is configured to execute any method for uplink transmission performed at a base station side as above.

Accordingly, the present disclosure further provides a communication device. The communication device includes:
a processor; and
a memory that stores instructions executable by a processor, where the processor is configured to implement any method for uplink transmission performed at a terminal side described above.

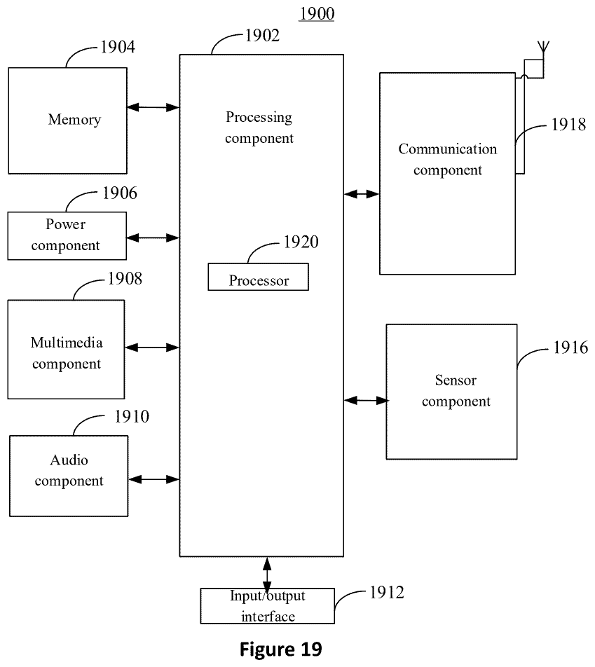

FIG. 19 is a block diagram of a communication device 1900 according to an example. For example, the communication device 1900 may be a terminal such as a mobile phone, a portable android device, an e-book reader, a multimedia playback device, a wearable device, a vehicle-mounted terminal, an iPad and a smart TV.

With reference to FIG. 19, the communication device 1900 may include one or more of components as follows: a processing component 1902, a memory 1904, a power component 1906, a multimedia component 1908, an audio component 1910, an input/output (I/O) interface 1912, a sensor component 1916, and a communication component 1918.

Generally, the processing component 1902 controls the overall operation of the communication device 1900, such as an operation associated with display, a telephone call, data communication, a camera operation, and a recording operation. The processing component 1902 may include one or more processors 1920 for executing instructions and completing all or some of the steps of the method for uplink transmission described above. In addition, the processing component 1902 may include one or more modules for interaction between the processing component 1902 and other components. For example, the processing component 1902 may include a multimedia module for interaction between the multimedia component 1908 and the processing component 1902. For example, the processing component 1902 may read executable instructions from the memory to implement steps of the method for uplink transmission according to the embodiments described above.

The memory 1904 is configured to store various types of data to support the operation of the communication device 1900. Instances of such data include instructions for any application or method operated on the communication device 1900, contact data, phonebook data, messages, pictures, videos, etc. The memory 1904 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power component 1906 provides electric power for various components of the communication device 1900. The power component 1906 may include a power management system, one or more power supplies, and other components associated with power generation, management and distribution for the communication device 1900.

The multimedia component 1908 includes a display screen providing an output interface between the communication device 1900 and a user. In some examples, the multimedia component 1908 includes a front-facing camera and/or a rear-facing camera. When the communication device 1900 is in an operating mode, such as a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 1910 is configured to output and/or input an audio signal. For example, the audio component 1910 includes a microphone (MIC). When the communication device 1900 is in an operating mode, such as a call mode, a recording mode or a voice recognition mode, the microphone is configured to receive an external audio signal. The audio signal received may be further stored in the memory 1904 or transmitted through the communication component 1918. In some examples, the audio component 1910 further includes a speaker for outputting the audio signal.

The I/O interface 1912 provides an interface between the processing component 1902 and a peripheral interface module. The peripheral interface module may be a keyboard, a click wheel, a button, etc. These buttons may include, but are not limited to a home button, a volume button, a start button, and a lock button.

The sensor component 1916 includes one or more sensors configured to provide state assessment in various aspects for the communication device 1900. For example, the sensor component 1916 may detect an on/off state of the communication device 1900, and relative localization of components, for example, a display and a keypad of the communication device 1900. The sensor component 1916 may further detect a location change of the communication device 1900 or a component of the communication device 1900, presence or absence of a touch between the user and the communication device 1900, an orientation or acceleration/deceleration of the communication device 1900, and a temperature change of the communication device 1900. The sensor component 1916 may include a proximity sensor configured to detect the presence of a nearby object without any physical touch. The sensor component 1916 may further include an optical sensor, such as a complementary metal-oxide-semiconductor transistor (CMOS) or charge-coupled device (CCD) image sensor for use in imaging applications. In some embodiments, the sensor component 1916 may further include an acceleration sensor, a gyroscope sensor, a magnetic sensor, a pressure sensor, or a temperature sensor.

The communication component 1918 is configured for wired or wireless uplink transmission between the communication device 1900 and other devices. The communication device 1900 may access a wireless network such as Wi-Fi, 2G, 3G, 4G, 5G, 6G or their combinations based on an uplink transmission standard. In an example, the communication component 1918 receives a broadcast signal or broadcast related information from an external broadcast management system via a broadcast channel. In an example, the communication component 1918 further includes a near field communication (NFC) module to promote short-range communication. For example, the NFC module may be implemented based on a radio-frequency identification (RFID) technology, an infrared data association (IrDA) technology, an ultra-wide band (UWB) technology, a Bluetooth (BT) technology, etc.

In an example, the communication device 1900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for executing the method for uplink transmission.

In an example, a non-transitory machine-readable storage medium including instructions is further provided, such as the memory 1904 including instructions. The instructions may be executed by the processor 1920 of the communication device 1900 for implementing the method for uplink transmission. For example, the non-transitory computer-readable storage medium may be a read-only memory (ROM), a random-access memory (RAM), a compact disc read-only memory (CD-ROM), a magnetic tape, a floppy disc, an optical data storage device, etc.

Accordingly, a communication device is further provided according to the present disclosure. The communication device includes:
a processor; and
a memory that stores instructions executable by a processor, where the processor is configured to implement any method for uplink transmission performed at a base station side described above.

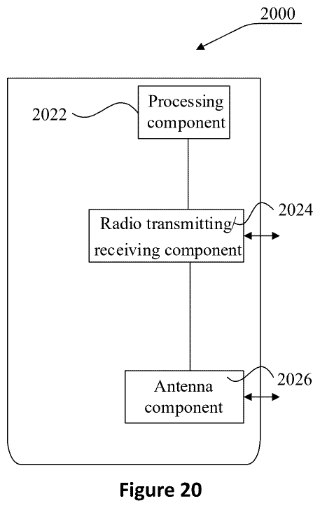

As shown in FIG. 20, FIG. 20 is a schematic structural diagram of a communication device 2000 according to an example. The communication device 2000 may be provided as a base station. With reference to FIG. 20, the communication device 2000 includes a processing component 2022, a radio transmitting/receiving component 2024, an antenna component 2026, and a signal processing portion unique to a radio interface, and the processing component 2022 may further include at least one processor.

One processor in the processing component 2022 may be configured to execute any method for uplink transmission described above.

The technical solution provided by the example of the present disclosure can have beneficial effects below.

In the example of the present disclosure, the terminal can receive the system message that includes the plurality of candidate numerical values and is transmitted by the base station. Further, the terminal can determine the first numerical value from the plurality of candidate numerical values. The terminal transmits the first preamble sequence to the base station, and while random access is completed through the first preamble sequence, a base station side can determine the first numerical value used by the terminal through the first preamble sequence. According to the present disclosure, in the satellite communication system, it effectively ensures that the base station and the terminal have a consistent understanding of numerical values for uplink transmission, thereby improving the reliability and effectiveness of the uplink transmission.

Those skilled in the art will readily conceive other implementations of the embodiments of the present disclosure upon consideration of the specification and practice of the present disclosure here. The present disclosure is intended to cover any variations, uses, or adaptations of the embodiments of the present disclosure. These variations, uses, or adaptations comply with the general principles of the embodiments of the present disclosure, and include common knowledge or customary technical means in the art which are not disclosed herein. The specification and embodiments are to be considered as illustrative merely, and the scope and spirit of the embodiments of the present disclosure are defined by the following claims.

It should be understood that the present disclosure is not limited to precise structures described above and shown in the accompanying drawings, and various modifications and changes can be made without departing from the scope of the present disclosure. The scope of the present disclosure is merely limited by the appended claims.

1. A method for transmitting information, performed by a terminal, comprising:
receiving a system message that comprises a plurality of candidate numerical values and is transmitted by a base station;
determining a first numerical value from the plurality of candidate numerical values; and
transmitting a first preamble sequence to the base station, wherein the first preamble sequence is configured to indicate the first numerical value.

2. The method according to claim 1, wherein the system message comprises first indication information, wherein the first indication information is configured to indicate an associated value of the first numerical value.

3. The method according to claim 2, wherein the associated value comprises at least one of an angle value of a link between the terminal and a satellite relative to a horizontal plane or
a timing advance (TA) value corresponding to the terminal.

4. The method according to claim 2, wherein determining the first numerical value from the plurality of candidate numerical values comprises:
determining the first numerical value corresponding to the associated value from the plurality of candidate numerical values.

5. The method according to claim 1, wherein the first numerical value has a correspondence relationship with the first preamble sequence.

6. The method according to claim 1, further comprising:
determining a first resource location corresponding to the first numerical value, wherein the first resource location is a resource location occupied by the first preamble sequence; and
transmitting the first preamble sequence to the base station comprises:
transmitting the first preamble sequence to the base station on the first resource location.

7. The method according to claim 1, further comprising:
determining that a variation of a TA value corresponding to the terminal exceeds a preset threshold;
transmitting a reconfiguration request message to the base station, wherein the reconfiguration request message is configured to request the base station to reconfigure a numerical value for the terminal; and
receiving a first update message transmitted by the base station, wherein the first update message comprises a new numerical value reconfigured by the base station for the terminal.

8. The method according to claim 1, further comprising:
receiving a second update message that is cyclically transmitted by the base station, wherein the second update message comprises a new numerical value reconfigured by the base station for the terminal.

9. The method according to claim 1, further comprising:
receiving a third update message transmitted by the base station, wherein the third update message comprises a plurality of new candidate numerical values reconfigured by the base station for the terminal;
determining a second numerical value from the plurality of new candidate numerical values; and
transmitting second indication information to the base station, wherein the second indication information is configured to indicate the second numerical value.

10. A method for receiving information, performed by a base station, comprising:
transmitting a system message comprising a plurality of candidate numerical values to a terminal;
receiving a first preamble sequence transmitted by the terminal, wherein the first preamble sequence is configured to indicate a first numerical value determined by the terminal from the plurality of candidate numerical values; and
determining the first numerical value used by the terminal based on the first preamble sequence.

11. The method according to claim 10, wherein the system message comprises first indication information, wherein the first indication information is configured to indicate an associated value of the first numerical value.

12. The method according to claim 11, wherein the associated value comprises at least one of an angle value of a link between the terminal and a satellite relative to a horizontal plane or
a TA value corresponding to the terminal.

13. The method according to claim 10, wherein determining the first numerical value used by the terminal based on the first preamble sequence comprises:
determining the first numerical value corresponding to the first preamble sequence; or
determining the first numerical value used by the terminal based on the first preamble sequence comprises:
determining a first resource location occupied by the first preamble sequence; and
determining the first numerical value corresponding to the first resource location.

14. (canceled)

15. The method according to claim 10, further comprising:
receiving a reconfiguration request message transmitted by the terminal, wherein the reconfiguration request message is configured to request the base station to reconfigure a numerical value for the terminal; and
transmitting a first update message to the terminal, wherein the first update message comprises a new numerical value reconfigured by the base station for the terminal.

16. The method according to claim 10, further comprising:
transmitting a second update message to the terminal cyclically, wherein the second update message comprises a new numerical value reconfigured by the base station for the terminal.

17. The method according to claim 10, further comprising:
transmitting a third update message to the terminal, wherein the third update message comprises a plurality of new candidate numerical values reconfigured by the base station for the terminal;
receiving second indication information transmitted by the terminal to the base station, wherein the second indication information is configured to indicate a second numerical value, and the second numerical value is determined by the terminal from the plurality of new candidate numerical values; and
determining the second numerical value used by the terminal based on the second indication information.

18. (canceled)

19. (canceled)

20. A non-transitory computer-readable storage medium, storing a computer program, wherein the computer program when executed by one or more processors cause the one or more processors to collectively execute the method for transmitting information according to claim 1.

21. A non-transitory computer-readable storage medium, storing a computer program, wherein the computer program when executed by one or more processors cause the one or more processors to collectively execute the method for receiving information according to claim 10.

22. A communication device, comprising:
one or more processors; and
a memory that stores instructions executable by the one or more processors, wherein the one or more processors are configured to execute the instructions and the instructions cause the communication device to:
receive a system message that comprises a plurality of candidate numerical values and is transmitted by a base station;
determine a first numerical value from the plurality of candidate numerical values; and
transmit a first preamble sequence to the base station, wherein the first preamble sequence is configured to indicate the first numerical value.

23. A communication device, comprising:
one or more processors; and
a memory that stores instructions executable by the one or more processors, wherein the one or more processors are configured to execute the instructions and the instructions cause the communication device to perform the method for receiving information according to claim 10.
